(19) United States
(12) Patent Application Publication
(10) Pub. No.: US 2007/0295878 A1
(43) Pub. Date: Dec. 27, 2007

(54) Secure link bracket assembly

(76) Inventor: Ole Falk Smed, Calgary (CA)

Correspondence Address: NEXSEN PRUET, LLC, P.O. BOX 10648, GREENVILLE, SC, 29603, US

(21) Appl. No.: 11/803,672

(22) Filed: May 15, 2007

Related U.S. Application Data
(60) Provisional application No. 60/800,514, filed on May 15, 2006.

(51) Int. Cl. F16M 11/00

(52) U.S. Cl. 248/413

(57) ABSTRACT

A link bracket assembly for a flat screen support device incorporates a locking set screw which prevents removal of the link bracket and appended support arm and device by insertion of the set screw into a circumferential groove in the support shaft dependent from the link bracket. A modification uses a hat-type washer secured to the shaft to form the locking groove and locking tabs and a rotation limiting foot on a washer to prevent full rotation of the link bracket.

### FIELD OF THE INVENTION

This invention relates to secure mounting attachments- link brackets- for devices such as support arms used to locate computer peripherals in workplaces and homes.

### BACKGROUND AND PRIOR ART

Numerous devices based upon parallelograms and springs are used to support television screens, computer monitors and keyboards. Examples are found in U.S. Pat. Nos. 6,758,454 and 6,695,270 and references cited therein. Most attach to a piece of furniture such as an office desk and or to a fixture mounted to a wall.

Mountings typically allow 360° of rotation, even when there is insufficient room for the parallelogram arms and devices to clear, and are held in place by the weight of the arm and device. As arms of this type become more popular and appear in public locations such as schools, libraries and service counters, theft and vandalism becomes inevitable. Concentrations of such arms limit to available room for movement even when wall do not impose such restrictions. Thus, there is a need to prevent theft of the devices and to limit the range of motion of the arms.

### BRIEF DESCRIPTION OF THE INVENTION

It is a first object of the invention to provide theft protection for flat screen display support arms. It is a second object of the invention to prevent inadvertent damage to flat screen display support arms. It is a third object of the invention to facilitate easy removal of flat screen display support arms by persons authorized to make repairs. It is a fourth objective of the invention to provide an adjustable means to limit rotation of an arm to less than 360°.

These and other objects of the invention are attained by use of a locking screw inserted into a mounting hub and a groove receiving the screw in the base of a link bracket shaft or in a washer secured thereto. The washer may be circular or have projections contacting splines in the mounting hub and link bracket shaft.

### BRIEF DESCRIPTION OF THE DRAWINGS

FIG. 1 is a side elevation of a link bracket retention assembly.

FIG. 2 is a section of FIG. 1 along line A-A.

FIG. 3 is a section of FIG. 1 along line B-B.

FIG. 4 is an exploded view of a link bracket retention assembly according to a first embodiment.

FIG. 5 is a side elevation of a link bracket retention assembly according to a second embodiment.

FIG. 6 is a section of FIG. 5 along line A-A.

FIG. 7 is a side elevation of a link bracket assembly having limited rotation.

FIG. 8 is a section of FIG. 7 along line A-A.

FIG. 9 is a section of FIG. 7 along line C-C.

FIG. 10 is an exploded view of a link bracket assembly accordingly to FIG. 7.

### DETAILED DESCRIPTION OF THE INVENTION

The link bracket retention assembly connects a flat panel display screen or other computer accessory to a rigid mount such as a wall bracket, desk or workbench. The link bracket is a turret upon which one end of a parallelogram support arm is mounted and has locations for two axles which form pivot points for inner and outer arms and an adjustment system to adjust spring tension within the parallelogram arms to compensate for the weight of the supported components.

The link bracket swivels on a shaft inserted into the hub of the link bracket retention assembly and is normally held in place by the weight of the components supported. The mounting is bushed and rotates through 360°, a degree of freedom which may be undesirable due to walls, other displays or other nearby equipment.

In the first embodiment of this invention, a set screw in combination with a receiving groove is used to retain the link bracket within the hub.

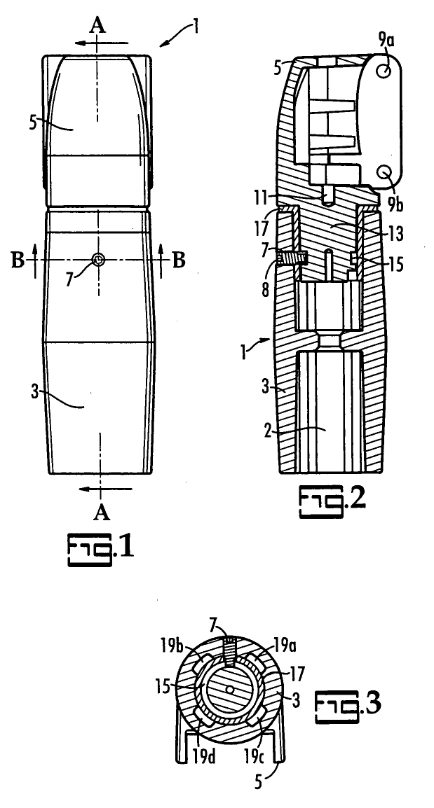

FIG. 1 illustrates in side elevation the assembly 1. The hub 3 slides over a tubular bracket or pipe (not shown) and supports the link bracket 5. A set screw 7 threads into a tapped hole in the bracket. FIG. 2 shows the assembly sectioned along lines A-A. The hub 3, with an opening 2 to accept a pipe or other connector mounted on a wall or desk supports the link bracket 5 on a flanged bushing 17, which receives turret shaft 13. The link bracket 5 supports axle carriers 9a, 9b which hingedly support the outer and inner arms. A jackscrew 11 adjusts tension on an internal spring, as is conventional.

A groove 15, formed circumferentially in a lower portion of turret shaft 13 receives set screw 7. The set screw has a penetrating end which is not threaded and an internal head 8 which accepts one of a number of bits. The bits may be conventional six-sided “Allen” wrenches or any of a number of odd and even numbered geometric figures. The more unique the head design, the more rare the bit required and the greater the level of security.

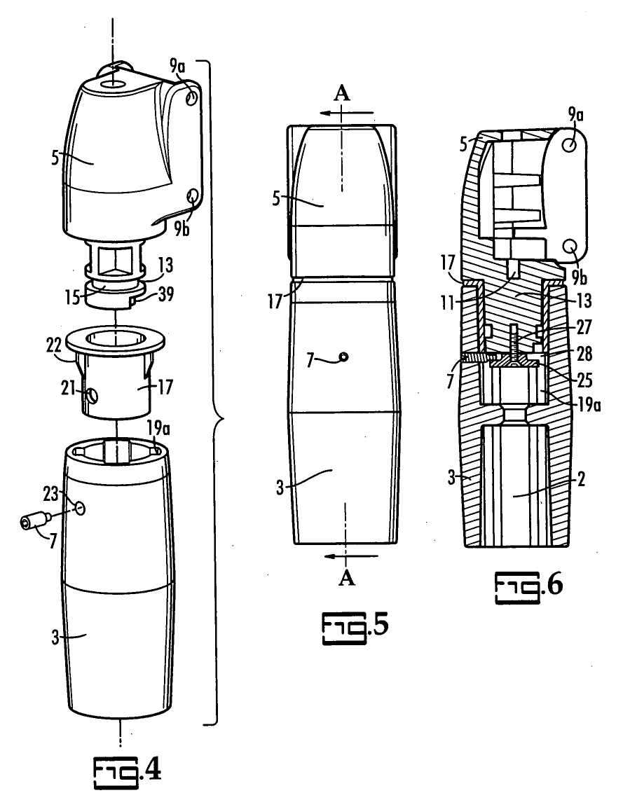

FIG. 3 is a section of FIG. 1 along line B-B and illustrates the relationship between the set screw 7 and groove 15. Also apparent are splines 19a-d formed in the hub. When splines 19a-d match similar splines on support 2, the hub is locked and cannot rotate. Rotation then depends upon the freedom of turret 5 to rotate upon hub 3.

FIG. 4 is an exploded view of the components of FIGS. 1-3 showing flanges 22 on bushing 17 and hole 21 through the bushing. Flanges 22 hold the bushing in place while hole 21 receives set screw 7, aligning with groove 15 of shaft 13. In this embodiment the shaft 13 rotates within the bushing but the bushing is locked into place.

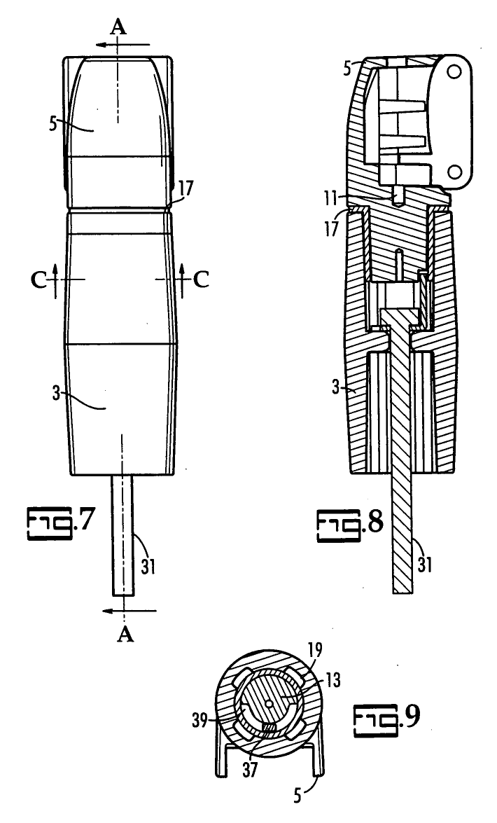

In a second embodiment, shown in FIG. 5 and FIG. 6, a section of FIG. 5 along line A-A, turret shaft 13 is truncated to eliminate the groove. A hat-type washer 25 is mounted beneath the shaft using a countersunk flat head screw 27 so that a groove 28 is created between the brim of the washer and the bottom surface of the shaft. Set screw 7 penetrates the groove and holds the link bracket in place.

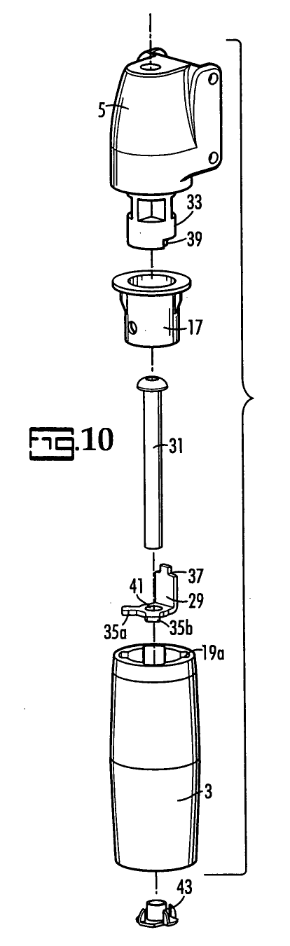

In a third embodiment, the rotation of the link bracket is limited by an anti-rotation washer. In side elevation FIG. 7, a long screw 31 extends into and optionally below the base of hub 3. When viewed in section along line A-A, (FIG. 8) it can be seen that buttonhead screw 31 retains an anti-rotation washer 29 at the base of turret shaft 13. The anti-rotation washer 29, best seen in FIG. 10, has a central hole 41, projecting lock tabs 35a and 35b and stop limiting arm 37. Lock tabs engage splines 19—which specific splines depends upon the rotation to be allowed—whilst arm 37 projects vertically into a section of shaft 13 created by a sector of a circular ring 39 on the circumferential surface of modified turret shaft 33, as shown in exploded view in FIG. 10. FIG. 9, a section of FIG. 7 along line C-C, illustrates the relationship of the foot 37 to the sector 39 and how the rotation of shaft 13 is limited. As can be seen from FIG. 10, the size of arm 37 or the size of the section of the circular ring 39 determines the degree of rotation.

FIG. 10 does not include a locking set screw but obvious modification includes the locking feature within the scope of the invention.

Exploded view FIG. 10 illustrates the orientation of components including T-nut 43 which draws down screw 31.

### INDUSTRIAL UTILITY

The invention provides for the retention of flat screw display arms in public places as a deterrent to theft and also protects the flat screen devices by limiting rotation of the support arms so that contact with solid objects can be avoided.

The invention has been described in terms of preferred embodiments modifications which are apparent to persons with skill are subsumed within the scope of this invention and the appended claims.

I claim:

1. A link bracket retention system for a flat screen display device support arm characterized by a set screw inserted through a mounting hub and engaging a groove in an extended portion of a turret shaft integral with a support arm link bracket.

2. A link bracket retention system according to claim 1 wherein the groove is formed between the bottom of said turret shaft and a hat-type washer secured to said shaft.

3. A link bracket system for limiting bracket rotation wherein a washer includes tabs locking said washer into a hub and a foot engaging a turret shaft to limit the rotation thereof.
